(19) United States
(12) Patent Application Publication
(10) Pub. No.: US 2026/0129320 A1
(43) Pub. Date: May 7, 2026

(54) SOLID-STATE IMAGING DEVICE AND DRIVING METHOD THEREOF, AND ELECTRONIC APPARATUS

(71) Applicant: SONY GROUP CORPORATION, TOKYO (JP)

(72) Inventor: KENZABURO SEKI, TOKYO (JP)

(21) Appl. No.: 19/119,418

(22) PCT Filed: Oct. 2, 2023
(86) PCT No.: PCT/JP2023/035839

§ 371 Date: Apr. 9, 2025

(30) Foreign Application Priority Data
Oct. 17, 2022 (JP) 2022-166320

(51) Int. Cl. H04N 25/78; H04N 25/704

(52) U.S. Cl. CPC H04N 25/78; H04N 25/704

(57) ABSTRACT

The present disclosure relates to a solid-state imaging device, a driving method thereof, and an electronic apparatus that enable a predetermined special pixel to be read multiple times during one sequence for reading a single screen.

The solid-state imaging device includes a pixel array unit in which a plurality of pixels including normal pixels and special pixels are arranged two-dimensionally in a matrix; and a driving unit that controls reading of signals generated by the pixels. The driving unit performs control to read a predetermined special pixel multiple times during a single-screen readout period in which the normal pixels of the pixel array unit are read once. The present disclosure can be applied to, for example, a solid-state imaging device and the like.

### TECHNICAL FIELD

The present disclosure relates to a solid-state imaging device and a driving method thereof, and an electronic apparatus, and in particular, to a solid-state imaging device and a driving method thereof, and an electronic apparatus that enable a predetermined special pixel to be read multiple times during one sequence for reading a single screen.

### BACKGROUND ART

There is known an imaging element in which normal pixels, which are pixels used for image output, and phase-difference pixels, which are used for focus detection, are arranged in a pixel array unit in which multiple pixels are arranged in a matrix. With regard to such an imaging element, there is an imaging element that shortens the time until the end of phase difference detection by separating driving into driving to be performed in a first period in which the signal of the normal pixel is read and into driving to be performed in a second period in which the signal of the phase-difference pixel is read, thereby shortening the time from the start of imaging to the completion of focusing, so as to improve the focusing response (see, for example, PTL 1).

### CITATION LIST

### Patent Literatures

[PTL 1]

JP 2013-223054A

### SUMMARY

### Technical Problem

In a solid-state imaging device, a special pixel such as a phase-difference pixel arranged in a pixel array unit is generally read once during one sequence for reading a single screen, and multiple readings have not been considered.

The present disclosure has been made in consideration of such a situation, and aims to enable a predetermined special pixel to be read multiple times during one sequence for reading a single screen.

### Solution to Problem

A solid-state imaging device of a first aspect of the present disclosure includes a pixel array unit in which a plurality of pixels including normal pixels and special pixels are arranged two-dimensionally in a matrix; and a driving unit that controls reading of signals generated by the pixels, wherein the driving unit performs control to read a predetermined special pixel out of the special pixels multiple times during a single-screen readout period in which the normal pixels of the pixel array unit are read once.

A method for driving a solid-state imaging device according to a second aspect of the present disclosure includes causing a driving unit of a solid-state imaging device including a pixel array unit in which a plurality of pixels including normal pixels and special pixels are arranged two-dimensionally in a matrix, and a driving unit that controls reading of signals generated by the pixels, to perform control to read a predetermined special pixel out of the special pixels multiple times during a single-screen readout period in which the normal pixels of the pixel array unit are read once.

An electronic apparatus according to a third aspect of the present disclosure includes a solid-state imaging device including a pixel array unit in which a plurality of pixels including normal pixels and special pixels are arranged two-dimensionally in a matrix, and a driving unit that controls reading of signals generated by the pixels, the driving unit performing control to read a predetermined special pixel out of the special pixels multiple times during a single-screen readout period in which the normal pixels of the pixel array unit are read once.

In the first to third aspects of the present disclosure, control is performed to read a predetermined special pixel multiple times during a single-screen readout period in which normal pixels of a pixel array unit in which a plurality of pixels, including normal pixels and special pixels, are arranged two-dimensionally in a matrix are read once.

The solid-state imaging device and electronic apparatus may be independent devices or may be modules integrated into other devices.

### BRIEF DESCRIPTION OF DRAWINGS

FIG. 1 is a diagram illustrating a schematic configuration of a solid-state imaging device to which the technology of the present disclosure is applied.

FIG. 2 is a diagram illustrating an equivalent circuit of a pixel.

FIG. 3 is a diagram illustrating an example of the arrangement of special pixels in a pixel array unit.

FIG. 4 is a diagram explaining a first drive that can be performed by the solid-state imaging device of FIG. 1.

FIG. 5 is a diagram explaining a second drive that can be performed by the solid-state imaging device of FIG. 1.

FIG. 6 is a diagram explaining a third drive that can be performed by the solid-state imaging device of FIG. 1.

FIG. 7 is a diagram further explaining the details of the third drive.

FIG. 8 is a diagram illustrating another example of the arrangement of special pixels in the pixel array unit.

FIG. 9 is a table explaining the readout pixels in the third drive in the arrangement example of FIG. 8.

FIG. 10 is a diagram explaining the third drive in the arrangement example of FIG. 8.

FIG. 11 is a diagram explaining the exposure time of a read-target special pixel.

FIG. 12 is a timing chart illustrating a first example of multiple-readout drive of a special pixel line in the arrangement example of FIG. 8.

FIG. 13 is a timing chart illustrating another example of first multiple-readout drive of a special pixel line in the arrangement example of FIG. 8.

FIG. 14 is a timing chart illustrating a second example of multiple-readout drive of a special pixel line in the arrangement example of FIG. 8.

FIG. 15 is a timing chart illustrating a third example of multiple-readout drive of a special pixel line in the arrangement example of FIG. 8.

FIG. 16 is a block diagram illustrating another example of the circuit configuration of the solid-state imaging device of FIG. 1.

FIG. 17 is a timing chart illustrating a fourth example of multiple-readout drive in the case of a double ADC configuration.

FIG. 18 is a block diagram illustrating an example of the configuration of an imaging device as an electronic apparatus to which the technology of the present disclosure is applied.

FIG. 19 is a diagram explaining an example of the use of an image sensor.

### DESCRIPTION OF EMBODIMENTS

Modes for embodying the technology of the present disclosure (hereinafter referred to as “embodiments”) will be described below with reference to the accompanying drawings. Note that in the present specification and the drawings, components having substantially the same functional configurations will be denoted by the same reference numerals, and repeated descriptions thereof will be omitted. The description will be made in the following order.
1. Schematic configuration example of solid-state imaging device
2. Circuit configuration example of pixel
3. Arrangement example of special pixels
4. First drive (raster-scan drive)
5. Second drive (time-division drive)
6. Third drive (multiple-readout drive)
7. Other example of third drive
8. Example of solid-state imaging device with double ADC configuration
9. Summary
10. Examples of applications to electronic apparatuses

### 1. Schematic Configuration Example of Solid-State Imaging Device

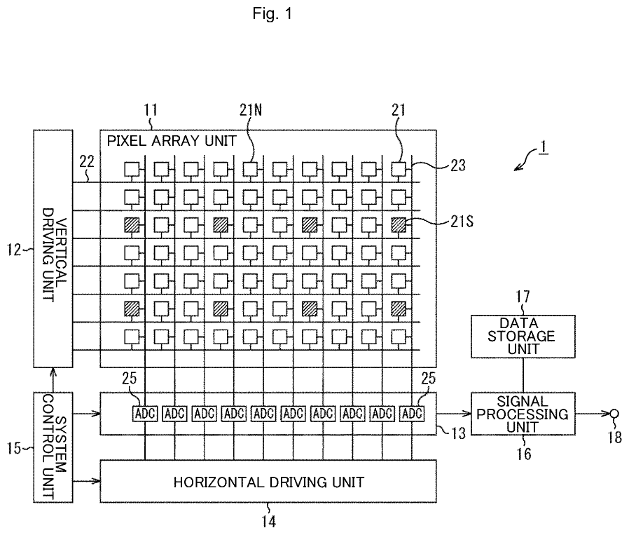

FIG. 1 is a diagram illustrating a schematic configuration of a solid-state imaging device to which the technology of the present disclosure is applied.

As a solid-state imaging device 1 in FIG. 1, a configuration of a CMOS image sensor, which is a type of solid-state imaging device of an X-Y address scheme, for example, is illustrated. The CMOS image sensor is an image sensor manufactured by applying or partially using a CMOS process.

The solid-state imaging device 1 includes a pixel array unit 11 and a peripheral circuit unit. The peripheral circuit unit includes, for example, a vertical driving unit 12, a column processing unit 13, a horizontal driving unit 14, and a system control unit 15.

The solid-state imaging device 1 further includes a signal processing unit 16 and a data storage unit 17. The signal processing unit 16 and the data storage unit 17 may be mounted on the same substrate as the pixel array unit 11, the vertical driving unit 12, and the like, or may be arranged on a separate substrate. The signal processing unit 16 and the data storage unit 17 may also be configured as a DSP (Digital Signal Processor) or the like on a semiconductor chip separate from the solid-state imaging device 1.

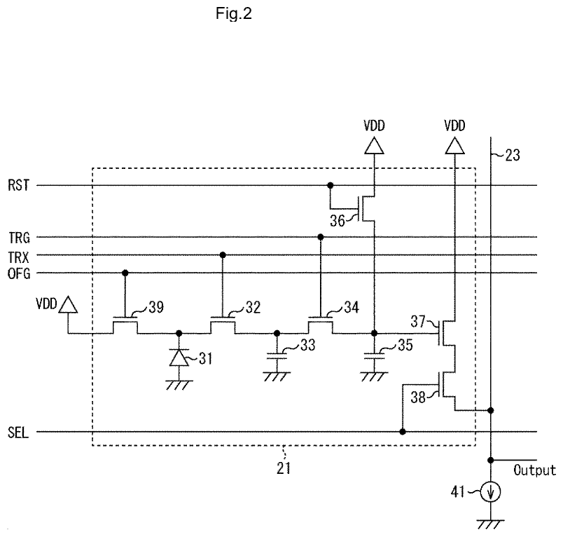

The pixel array unit 11 has a configuration in which pixels 21, each having a photoelectric conversion unit (for example, a photodiode) that generates and accumulates a charge according to the amount of light received, are arranged two-dimensionally in a matrix in the row and column directions. Here, the row direction denotes an arrangement direction of pixel rows of the pixel array unit 11, that is, in a horizontal direction, while the column direction denotes an arrangement direction of pixel columns of the pixel array unit 11, that is, in a vertical direction. An exemplary circuit configuration of the pixel 21 will be described with reference to FIG. 2.

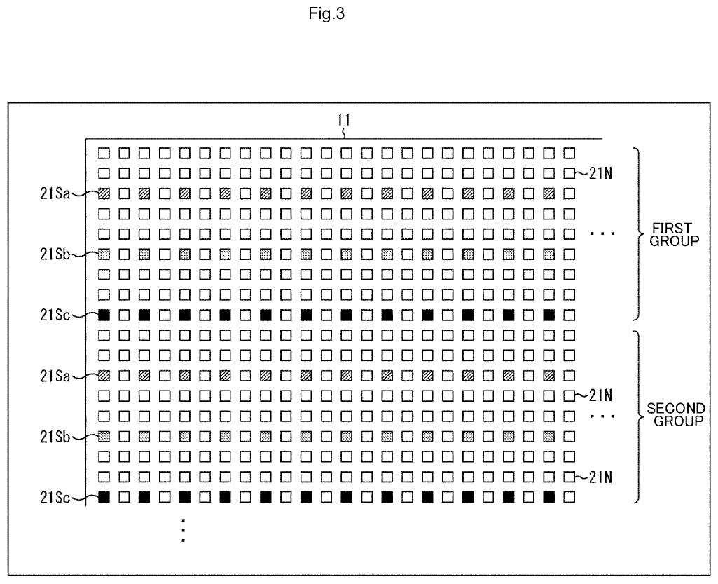

Two types of pixels 21, normal pixels 21N and special pixels 21S, are arranged in the pixel array unit 11. The normal pixels 21N are pixels that acquire and output a signal for image output, and the special pixels 21S are pixels that acquire and output a signal for a special purpose other than image output. The purpose of the special pixels 21S is to obtain and output a signal for a special purpose, but the obtained signal may be used as a signal for image output. Examples of the special pixels 21S include phase-difference pixels that output a signal for detecting a phase difference, detection pixels for recognition processing such as face recognition and pupil recognition, and functional pixels with a specific function. Functional pixels include, for example, polarization pixels that are equipped with a polarizing filter and receive only light with a specific polarization direction. The arrangement of the special pixels 21S in the pixel array unit 11 will be described later with reference to FIG. 3 and the like.

In the pixel array unit 11, pixel drive wiring 22 is wired in the row direction as a row signal line for each pixel row, and vertical signal lines 23 are wired in the column direction as column signal lines for each pixel column. The pixel drive wiring 22 transmits a drive signal for driving when reading a signal from the pixel 21. Although the pixel drive wiring 22 is illustrated as one wiring in FIG. 1, the number thereof is not limited to one. An end of the pixel drive wiring 22 is connected to an output terminal corresponding to each row of the vertical driving unit 12.

The vertical driving unit 12 is configured by a shift register, an address decoder, or the like, and drives each of the pixels 21 of the pixel array unit 11 at the same time, on a per-row basis, or the like. The vertical driving unit 12, together with the system control unit 15, constitutes a driving unit that controls the operation of each pixel 21 of the pixel array unit 11. Although an illustration of a specific configuration will be omitted, the vertical driving unit 12 typically has two scanning systems, namely a readout scanning system and a sweep-out scanning system.

The readout scanning system sequentially selects and scans the pixels 21 of the pixel array unit 11 on a row-by-row basis to read signals from the pixels 21. The signals read from the pixels 21 are analog signals. The sweep-out scanning system performs a sweep-out scanning on the readout row to be subjected to a readout scanning by the readout scanning system, at a time preceding the readout scanning by an exposure time.

By the sweep-out scanning by this sweep-out scanning system, unnecessary charges are swept out from the photoelectric conversion units of the pixels 21 in the readout row, and the photoelectric conversion units of each pixel 21 are reset. Then, by sweeping out (resetting) the unnecessary charges by this sweep-out scanning system, a so-called electronic shutter operation is performed. Here, the electronic shutter operation refers to an operation in which the charge of the photoelectric conversion unit is discarded and a new exposure is started (the accumulation of charge is started).

A signal read through the reading operation in the readout scanning system corresponds to the amount of light received after the immediately previous reading operation or the electronic shutter operation. Then, the period from the readout timing by the immediately previous reading operation or the sweep timing by the electronic shutter operation to the readout timing by the current reading operation is the exposure period of the pixel 21.

The signals output from each pixel 21 in the row selected and scanned by the vertical driving unit 12 are input to the column processing unit 13 through each vertical signal line 23 for each column. The column processing unit 13 has an ADC (Analog-Digital Converter) 25 for each column of the pixel array unit 11. The ADC 25 performs CDS (Correlated Double Sampling) processing and AD conversion processing. The CDS processing removes pixel-specific fixed pattern noise such as reset noise and threshold variation of the amplification transistor in the pixel. The AD conversion processing converts the analog pixel signal into a digital signal. The digital pixel signal after AD conversion is temporarily held inside the ADC 25 until it is read.

The horizontal driving unit 14 is composed of a shift register, an address decoder, and the like, and sequentially selects the ADCs 25 provided for each column in the column processing unit 13. By selective scanning by this horizontal driving unit 14, the pixel signals held inside the ADCs 25 in the column processing unit 13 are sequentially output to the signal processing unit 16.

The system control unit 15 is configured of a timing generator that generates various timing signals or the like, and performs drive control on the vertical driving unit 12, the column processing unit 13, the horizontal driving unit 14, and the like on the basis of various timings generated by the timing generator.

The signal processing unit 16 has at least a calculation processing function and performs various signal processing such as calculation processing on a pixel signal output from the column processing unit 13. The data storage unit 17 temporarily stores data required for signal processing in the signal processing unit 16. The pixel signal on which the signal processing unit 16 has performed the signal processing is converted into a predetermined format and is output to outside of the apparatus from the output unit 18.

### 2. Circuit Configuration Example of Pixel

FIG. 2 is an equivalent circuit diagram of the pixel 21.

The pixel 21 has a photodiode 31, a first transfer transistor 32, a memory unit (MEM) 33, a second transfer transistor 34, an FD (floating diffusion) 35, a reset transistor 36, an amplification transistor 37, a selection transistor 38, and a discharge transistor 39.

The photodiode 31 is a photoelectric conversion unit that generates and accumulates electric charge (signal charge) according to the amount of light received. The photodiode 31 has its anode terminal grounded and its cathode terminal connected to the memory unit 33 through the first transfer transistor 32. The cathode terminal of the photodiode 31 is also connected to the discharge transistor 39.

When turned on in response to a transfer signal TRX, the first transfer transistor 32 reads charge generated by the photodiode 31 and transfers the charge to the memory unit 33. The memory unit 33 is a charge holding unit that temporarily holds the charge until the charge is transferred to the FD 35. When the second transfer transistor 34 is turned on by a transfer signal TRG, it transfers the charge held in the memory unit 33 to the FD 35.

The FD 35 is a charge-voltage conversion unit that converts the charge read from the memory unit 33 into a voltage. When the reset transistor 36 is turned on by a reset signal RST, the charge held in the FD 35 is discharged to a constant voltage source VDD, thereby resetting the potential of the FD 35.

The amplification transistor 37 outputs a pixel signal according to the potential of the FD 35. That is, the amplification transistor 37 and the load MOS 41 as a constant current source form a source follower circuit, and a pixel signal indicating a level according to the charge held in the FD 35 is output from the amplification transistor 37 to the column processing unit 13 (FIG. 1) via the selection transistor 38. The load MOS 41 is provided, for example, in the column processing unit 13.

When the pixel 21 is selected by the selection signal SEL, the selection transistor 38 is turned on and outputs the signal of the pixel 21 to the column processing unit 13 via the vertical signal line 23. When the discharge transistor 39 is turned on by the discharge signal OFG, it discharges unnecessary charges accumulated in the photodiode 31 to the constant voltage source VDD. The transfer signals TRX and TRG, the reset signal RST, the selection signal SEL, and the discharge signal OFG are controlled by the vertical driving unit 12 and are supplied via the pixel drive wiring 22 (FIG. 1).

The operation of the pixel 21 will be briefly described.

First, before the start of exposure, a high-level discharge signal OFG is supplied to the discharge transistor 39, whereby the discharge transistor 39 is turned on. The charge accumulated in the photodiode 31 is discharged to the constant voltage source VDD, and the photodiode 31 is reset.

After the photodiode 31 is reset, the discharge transistor 39 is turned off by a low-level discharge signal OFG, and exposure begins in all pixels.

After a predetermined exposure time period elapses, the first transfer transistor 32 is turned on in response to the transfer signal TRX in all the pixels in the pixel array unit 11, and the charge accumulated in the photodiode 31 is transferred to the memory unit 33.

After the first transfer transistor 32 is turned off, the charges held in the memory unit 33 of each pixel 21 are sequentially read to the column processing unit 13 on a row-by-row basis. In the readout operation, first, the second transfer transistor 34 of the pixel 21 in the readout row is turned on by the transfer signal TRG, and the charge held in the memory unit 33 is transferred to the FD 35. Then, the selection transistor 38 is turned on by the selection signal SEL, and a signal indicating a level corresponding to the charge held in the FD 35 is output from the amplification transistor 37 to the column processing unit 13 via the selection transistor 38.

The pixel 21 having the pixel circuit described above can perform a global shutter type operation (imaging) in which the exposure time is set to be the same for all pixels in the pixel array unit 11, the charges are temporarily held in the memory unit 33 after the exposure is completed, and the charges are sequentially read from the memory unit 33 on a row-by-row basis.

Note that the circuit configuration of the pixel 21 is not limited to the configuration illustrated in FIG. 2, and a circuit configuration that operates without the memory unit 33 in a so-called rolling shutter manner may be used.

### 3. Example of Special Pixel Arrangement

As described above, two types of pixels 21, normal pixels 21N and special pixels 21S, are arranged two-dimensionally in a matrix in the pixel array unit 11 of the solid-state imaging device 1. The solid-state imaging device 1 is capable of performing raster-scan drive, which reads pixel signals from each pixel 21 arranged two-dimensionally in a matrix, starting from the first row, on a row-by-row basis, without distinguishing between the normal pixels 21N and the special pixels 21S. In addition, the solid-state imaging device 1 is also capable of performing driving to read only the pixel signals of the normal pixels 21N or only the pixel signals of the special pixels 21S among the pixels 21 in the pixel array unit 11. Furthermore, the solid-state imaging device 1 can perform driving to read a predetermined special pixel 21S multiple times during a single-screen readout period (hereinafter also referred to as a 1V period) for reading a single screen constituting a frame image.

Below, the arrangement of the special pixels 21S in the pixel array unit 11 will be described, along with various driving operations that the solid-state imaging device 1 can perform.

FIG. 3 is a diagram illustrating an example of the arrangement of the special pixels 21S in the pixel array unit 11 (first arrangement example).

The pixel array unit 11 is configured such that some of the normal pixels 21N arranged two-dimensionally in a matrix are replaced with the special pixels 21S. More specifically, the rows in the pixel array unit 11 include rows where only normal pixels 21N are arranged (hereinafter also referred to as normal pixel lines) and rows where both normal pixels 21N and special pixels 21S are arranged (hereinafter also referred to as special pixel lines). In the example of FIG. 3, the special pixel lines are arranged at intervals of two rows with two normal pixel lines therebetween. Furthermore, in one special pixel line, the normal pixels 21N and the special pixels 21S are arranged alternately in the row direction.

The special pixels 21S include three different types of special pixels 21S, i.e., type a, type b, and type c. In the row where the special pixels 21S are arranged, the same type of special pixels 21S are arranged, and the different types of special pixels 21S are arranged in different rows. In the example of FIG. 3, the special pixel 21Sa represents the type-a special pixel 21S, the special pixel 21Sb represents the type-b special pixel 21S, and the special pixel 21Sc represents the type-c special pixel 21S. In the special pixel lines arranged every two rows, the special pixel line of the type-a special pixel 21Sa, the special pixel line of the type-b special pixel 21Sb, and the special pixel line of the type-c special pixel 21Sc are arranged repeatedly in that order in the column direction. Here, using the upper left pixel from which the pixel signal of a single screen is first read in the raster-scan drive as the starting position, the first set of the special pixel line of the type-a special pixel 21Sa, the special pixel line of the type-b special pixel 21Sb, and the special pixel line of the type-c special pixel 21Sc is referred to as the first group of special pixel lines, and the second set of the special pixel line of the type-a special pixel 21Sa, the special pixel line of the type-b special pixel 21Sb, and the special pixel line of the type-c special pixel 21Sc is referred to as the second group of special pixel lines. Similarly, a predetermined number of groups of special pixel lines are arranged in the pixel array unit 11.

For example, when the special pixels 21S are phase-difference pixels, the differences in the types of special pixels 21S can be characterized by variations in the arrangement and area of the light shielding film formed above the photodiode, the direction of pupil division, and the like. Furthermore, for example, when the special pixels 21S are polarization pixels, differences in the types of special pixels 21S can be characterized by variations in the polarization direction of the light received.

The arrangement of the special pixels 21S in the pixel array unit 11 illustrated in FIG. 3 is merely an example, and arrangements of the special pixels 21S other than the example illustrated in FIG. 3 are naturally possible. In other words, the number of intervals between special pixel lines in the column direction and the number of intervals between special pixels 21S in one special pixel line in the row direction can be set arbitrarily. The number of types (kinds) of special pixels 21S is also not limited to three.

### 4. First Drive (Raster-Scan Drive)

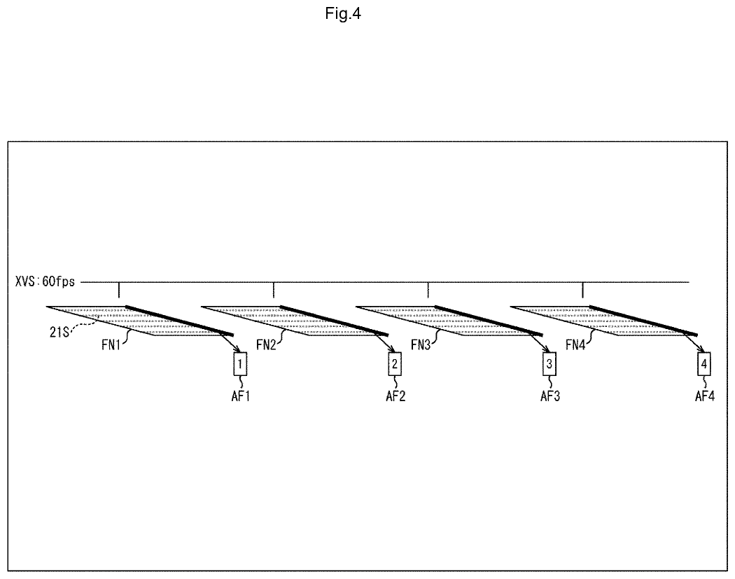

Next, raster-scan drive, which is the first drive that the solid-state imaging device 1 can perform for the pixel arrangement of the pixel array unit 11 illustrated in FIG. 3, will be described with reference to FIG. 4. In the following example, an example in which the special pixels 21S are phase-difference pixels will be described.

The solid-state imaging device 1 reads each pixel 21 of the pixel array unit 11 by raster-scan drive as the first drive. Specifically, the solid-state imaging device 1 reads all pixels 21 in the pixel array unit 11 on a row-by-row basis, starting from the first row, without distinguishing between normal pixels 21N and special pixels 21S. A frame image FN for image output is generated using pixel signals read from the normal pixels 21N of the pixel array unit 11, and an in-plane phase-difference signal AF is generated using phase-difference signals read from the special pixels 21S of the pixel array unit 11.

In FIG. 4, when the frequency of the vertical synchronization signal XVS is 60 Hz, the solid-state imaging device 1 outputs 60 frame images FN per second in the order of frame images FN1, FN2, FN3, FN4, and so on. The solid-state imaging device 1 also performs focus detection using in-plane phase-difference signals AF1, AF2, AF3, AF4, and so on obtained simultaneously with the frame images FN1, FN2, FN3, FN4, and so on.

In FIG. 4, the dots in the diamond shape representing the frame image FN represent the special pixels 21S. In the raster-scan drive, the timing at which the focus detection process can be started using the in-plane phase-difference signal AF read from the special pixels 21S is almost the same as the timing at which the readout of all the pixels 21 in the pixel array unit 11 is completed.

### 5. Second Drive (Time-Division Drive)

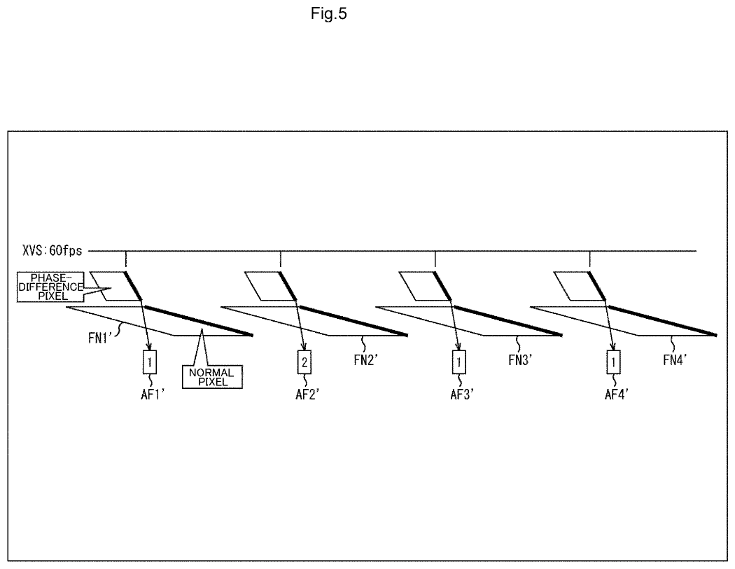

Next, referring to FIG. 5, the time-division drive, which is the second drive that can be performed by the solid-state imaging device 1, will be described.

In the time-division drive as the second drive, the solid-state imaging device 1 performs driving to read the special pixels 21S and driving to read the normal pixels 21N of all the pixels 21 in the pixel array unit 11 in a time-division manner. Specifically, first, the solid-state imaging device 1 sequentially reads the phase-difference signals of the special pixels 21S of all the pixels 21 in the pixel array unit 11 on a row-by-row basis. After reading the special pixels 21S, the solid-state imaging device 1 sequentially reads the pixel signals of the normal pixels 21N on a row-by-row basis. During the first frame period, an in-plane phase-difference signal AF1′ is output, after which the pixel signals of the normal pixels 21N that constitute the frame image FN1′ are output. During the second frame period, an in-plane phase-difference signal AF2′ is output, after which the pixel signals of the normal pixels 21N that constitute the frame image FN2′ are output. During the third frame period, an in-plane phase-difference signal AF3′ is output, after which the pixel signals of the normal pixels 21N that constitute the frame image FN3′ are output. The same applies below.

In the time-division drive, the focus detection process using the in-plane phase-difference signal AF′ can be started before the pixel signal of the normal pixel 21N is read.

### 6. Third Drive (Multiple-Readout Drive)

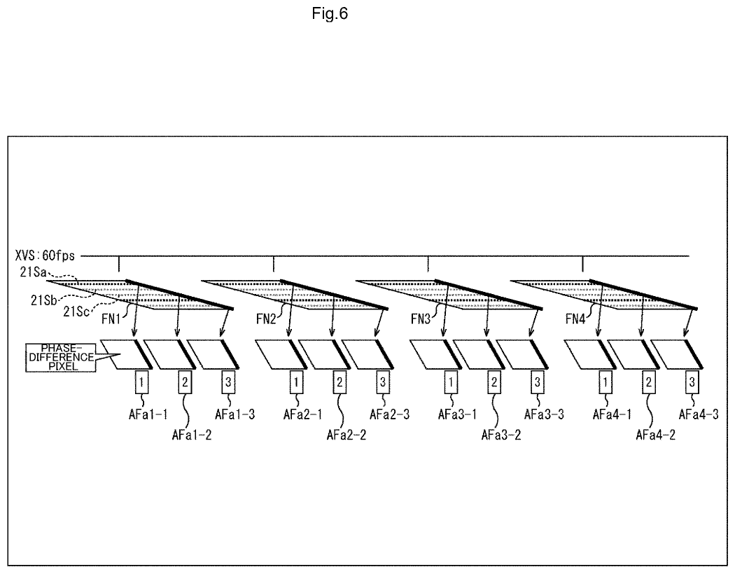

Next, referring to FIG. 6, the multiple-readout drive, which is the third drive that can be performed by the solid-state imaging device 1, will be described.

The multiple-readout drive is a driving in which a read-target predetermined special pixel 21S is read multiple times. In the above-mentioned raster-scan drive and time-division drive, even when there is a type of special pixel 21S that does not need to be read, the readout operation of the special pixel 21S that does not need to be read is performed, and the phase-difference signal read from the special pixel 21S that does not need to be read is supplied to the ADC 25, and the ADC 25 is in a state of operating unnecessarily. In addition, the read-target special pixel 21S can only be read once.

In the multiple-readout drive of the solid-state imaging device 1, when it is desired to obtain only the phase-difference signal of a specific type of special pixel 21S(for example, the type-a special pixel 21Sa) among the three types of special pixels 21S, that is, the type-a special pixel 21Sa, the type-b special pixel 21Sb, and the type-c special pixel 21Sc, the phase-difference signal of the one type of read-target special pixel 21S is read multiple times without reading the phase-difference signals of the other types of special pixels 21S(for example, the type-b special pixel 21Sb and the type-c special pixel 21Sc).

For example, a case will be described in which, among the three types of special pixels 21S, that is, the type-a special pixel 21Sa, the type-b special pixel 21Sb, and the type-c special pixel 21Sc, the phase-difference signal is read for the type-a special pixel 21Sa, and it is not necessary to read the phase-difference signals for the type-b special pixel 21Sb and the type-c special pixel 21Sc.

When the type-a special pixel 21Sa is the read-target pixel among the special pixels 21S in the pixel array unit 11, and the type-b special pixel 21Sb and the type-c special pixel 21Sc are pixels that do not need to be read, the solid-state imaging device 1 reads the phase-difference signal of the type-a special pixel 21Sa three times in one frame period (1V period).

Specifically, as illustrated in FIG. 6, in the first frame period, the solid-state imaging device 1 reads the pixel signals of the normal pixels 21N in the pixel array unit 11 that generate the frame image FN1 in a line-sequential manner in the raster-scan method, and reads the type-a special pixel 21Sa three times for the same pixel before reading the normal pixel line in the last row, and outputs three in-plane phase-difference signals AFa1-1, AFa1-2, and AFa1-3. In the next second frame period, the solid-state imaging device 1 reads the pixel signals of the normal pixels 21N in the pixel array unit 11 that generate the frame image FN2 in a line-sequential manner in the raster-scan method, and reads the type-a special pixel 21Sa three times for the same pixel before the normal pixel line of the last row is read, and outputs three in-plane phase-difference signals AFa2-1, AFa2-2, and AFa2-3. In the next third frame period, the solid-state imaging device 1 reads the pixel signals of the normal pixels 21N in the pixel array unit 11 that generate the frame image FN3 in a line-sequential manner in the raster-scan method, and reads the type-a special pixel 21Sa is read three times for the same pixel before the normal pixel line of the last row, and outputs three in-plane phase-difference signals AFa3-1, AFa3-2, and AFa3-3. The same applies below.

In the multiple-readout drive, the read-target special pixel 21Sa can be read at a readout speed three times faster than that of the raster-scan drive.

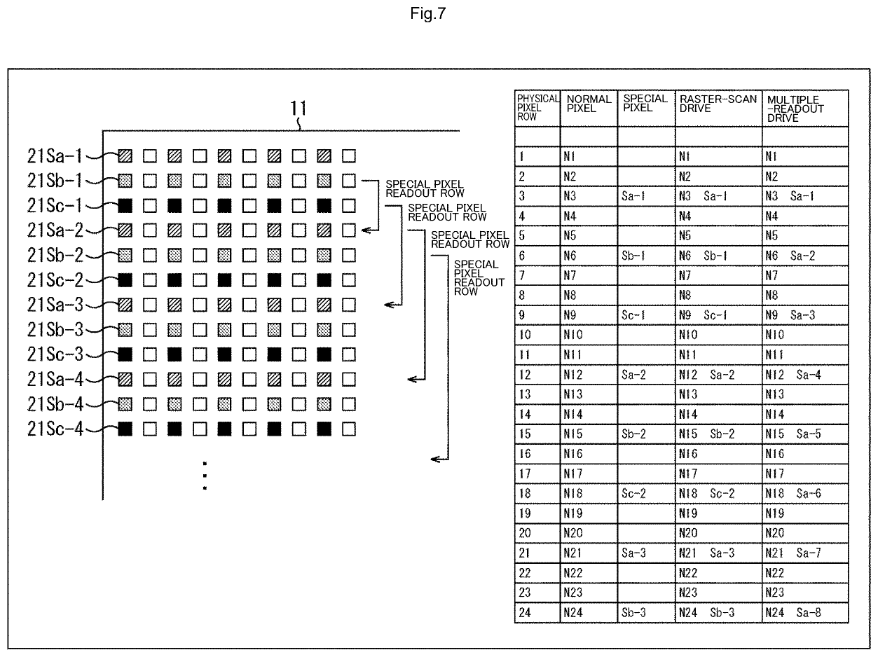

Details of the multiple-readout drive will be further described with reference to FIG. 7. In FIG. 7, the multiple-readout drive will be described in comparison with the raster-scan drive.

On the left side of FIG. 7, only the special pixel lines of the pixel array unit 11 are illustrated. On the right side of FIG. 7, a table is illustrated explaining the readout pixels of the raster-scan drive and the multiple-readout drive in each physical pixel row of the pixel array unit 11.

When the readout row of the pixel array unit 11 corresponds to the first and second physical pixel rows, the first and second rows are normal pixel lines, so that the solid-state imaging device 1 reads the normal pixels 21N of each row in a column-parallel manner in both the raster-scan drive and the multiple-readout drive.

Next, when the readout row of the pixel array unit 11 corresponds to the third physical pixel row, the normal pixels 21N and the first group of type-a special pixels 21Sa-1 are arranged alternately in the third row. In both the raster-scan drive and the multiple-readout drive, the solid-state imaging device 1 reads the normal pixel 21N in the third row and the special pixel 21Sa-1 in a column-parallel manner.

Next, when the readout row of the pixel array unit 11 is the fourth or fifth physical pixel row, the fourth and fifth rows are normal pixel lines, so that the solid-state imaging device 1 reads the normal pixel 21N in each row in a column-parallel manner in both the raster-scan drive and the multiple-readout drive.

Next, when the readout row of the pixel array unit 11 is the sixth physical pixel row, the normal pixel 21N and the first group of type-b special pixel 21Sb-1 are arranged alternately in the sixth row. In the raster-scan drive, the solid-state imaging device 1 reads the normal pixel 21N in the sixth row and the first group of type-b special pixel 21Sb-1 in the sixth row in a column-parallel manner. On the other hand, in the case of multiple-readout drive, the solid-state imaging device 1 reads the normal pixel 21N in the sixth row and the second group of type-a special pixels 21Sa-2 in the 12th row in a column-parallel manner. That is, when reading the special pixels 21S, instead of reading the first group of type-b special pixels 21Sb-1 in the sixth row, the second group of type-a special pixels 21Sa-2 in the 12th row are read.

Next, when the readout row of the pixel array unit 11 corresponds to the seventh and eighth physical pixel rows, the seventh and eighth rows are normal pixel lines, so that the solid-state imaging device 1 reads the normal pixels 21N in each row in a column-parallel manner in both the raster-scan drive and the multiple-readout drive.

Next, when the readout row of the pixel array unit 11 corresponds to the ninth physical pixel row, the normal pixels 21N and the first group of type-c special pixels 21Sc-1 are arranged alternately in the ninth row. In the case of raster-scan drive, the solid-state imaging device 1 reads the normal pixel 21N of the ninth row and the first group of type-c special pixels 21Sc-1 in the ninth row in a column-parallel manner. On the other hand, in the case of multiple-readout drive, the solid-state imaging device 1 reads the normal pixels 21N of the ninth row and the third group of type-a special pixels 21Sa-3 in the 21st row in a column-parallel manner. In other words, when reading the special pixels 21S, instead of reading the first group of type-c special pixels 21Sc-1 in the ninth row, the third group of type-a special pixels 21Sa-3 in the 21st row are read.

Next, when the readout row of the pixel array unit 11 corresponds to the 10th or 11th physical pixel row, the 10th and 11th rows are normal pixel lines, so the solid-state imaging device 1 reads the normal pixels 21N of each row in a column-parallel manner in both raster-scan drive and multiple-readout drive.

Next, when the readout row of the pixel array unit 11 corresponds to the 12th physical pixel row, the normal pixels 21N and the second group of type-a special pixels 21Sa-2 are arranged alternately in the 12th row. In the case of raster-scan drive, the solid-state imaging device 1 reads the normal pixels 21N in the 12th row and the second group of type-a special pixels 21Sa-2 in the 12th row in a column-parallel manner. On the other hand, in the case of multiple-readout drive, the solid-state imaging device 1 reads the normal pixels 21N in the 12th row and the fourth group of type-a special pixels 21Sa-4 in the 30th row in a column-parallel manner. As for the second group of type-a special pixels 21Sa-2 in the 12th row, since these pixels have already been read during the readout of the sixth physical pixel row, instead of reading the second group of type-a special pixels 21Sa-2 in the 12th row, the fourth group of type-a special pixels 21Sa-4 in the 30th row are read.

Next, when the readout row of the pixel array unit 11 corresponds to the 13th and 14th physical pixel rows, the 13th and 14th rows are normal pixel lines, so the solid-state imaging device 1 reads the normal pixels 21N of each row in a column-parallel manner in both the raster-scan drive and the multiple-readout drive.

Next, when the readout row of the pixel array unit 11 is the 15th physical pixel row, the normal pixel 21N and the second group of type-b special pixels 21Sb-2 are arranged alternately in the 15th row. In the case of raster-scan drive, the solid-state imaging device 1 reads the normal pixels 21N in the 15th row and the second group of type-b special pixels 21Sb-2 in the 15th row in a column-parallel manner. On the other hand, in the case of multiple-readout drive, the solid-state imaging device 1 reads the normal pixels 21N in the 15th row and the fifth group of type-a special pixels 21Sa-5 in the 39th row in a column-parallel manner.

Next, when the readout row of the pixel array unit 11 corresponds to the 16th or 17th physical pixel row, the 16th and 17th rows are normal pixel lines, so the solid-state imaging device 1 reads the normal pixels 21N of each row in a column-parallel manner in both raster-scan drive and multiple-readout drive.

Next, when the readout row of the pixel array unit 11 corresponds to the 18th physical pixel row, the normal pixels 21N and the second group of type-c special pixels 21Sc-2 are arranged alternately in the 18th row. In the case of raster-scan drive, the solid-state imaging device 1 reads the normal pixels 21N of the 18th row and the second group of type-c special pixels 21Sc-2 of the 18th row in a column-parallel manner. On the other hand, in the case of multiple-readout drive, the solid-state imaging device 1 reads the normal pixels 21N in the 18th row and the sixth group of type-a special pixels 21Sa-6 in the 48th row in a column-parallel manner.

The readout of the pixel array unit 11 for rows from the 19th physical pixel row onward follows the same rule.

As described above, in the case of multiple-readout drive, when the readout row of the pixel array unit 11 corresponds to a special pixel line, the solid-state imaging device 1 sequentially selects the special pixel line in which the read-target special pixels 21Sa are arranged, and reads only the special pixel 21Sa first for the special pixels 21S. The readout of the special pixels 21Sb and 21Sc that do not need to be read is skipped, so the readout row of the special pixel 21Sa reaches the last row of the pixel array unit 11 earlier than the readout row of the normal pixel 21N. When the last row of the pixel array unit 11 is reached, the special pixel line in which the read-target special pixel 21Sa is arranged is selected again from the first row of the pixel array unit 11 in sequence. The readout of the special pixels 21S in the special pixel line of the type-b special pixel 21Sb and the special pixel line of the type-c special pixel 21Sc is skipped, so the special pixel line of the type-a special pixel 21Sa is read three times.

### 7. Other Examples of Third Drive

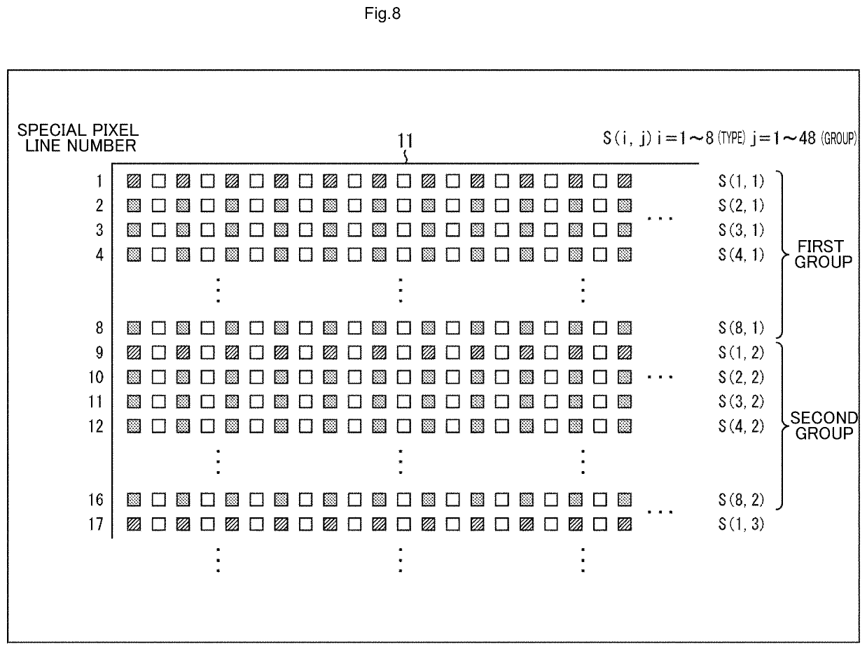

Next, referring to FIGS. 8 to 10, the multiple-readout drive, which is the third drive of the solid-state imaging device 1, will be described using a different arrangement pattern of the special pixels 21S as an example.

FIG. 8 is a diagram illustrating another arrangement example (second arrangement example) of the special pixels 21S, which is different from the arrangement example of the special pixels 21S illustrated in FIG. 3. Note that in FIG. 8, due to space limitations, only the special pixel line in the pixel array unit 11 is illustrated.

In the second arrangement example of the special pixels 21S illustrated in FIG. 8, there are eight types of special pixels 21S, from the first type to the eighth type, and 48 sets (48 groups) of special pixel lines of the eight types of special pixels 21S are arranged in the column direction in the pixel array unit 11.

Now, focusing only on the special pixel lines of the pixel array unit 11, the special pixel line with the special pixel line number “1” has the first group of first-type special pixels 21S arranged therein, and the special pixels 21S of this special pixel line are described as special pixels 21S(1,1). In the special pixels 21S(i, j), i represents type and j represents group. The special pixel line with the special pixel line number “2” has the first group of second-type special pixels 21S(2,1) arranged therein. The special pixel line with the special pixel line number “3” has the first group of third-type special pixels 21S(3,1) arranged therein. The special pixel line with the special pixel line number “4” has the first group of fourth-type special pixels 21S(4,1) arranged therein. Similarly, the special pixel line with the special pixel line number “8” has the first group of eighth-type special pixels 21S(8,1) arranged therein.

Then, the special pixel line with the special pixel line number “9” has the second group of first-type special pixels 21S(1,2) arranged therein. The special pixel line with the special pixel line number “10” has the second group of second-type special pixels 21S(2,2) arranged therein. The special pixel line with the special pixel line number “11” has the second group of third-type special pixels 21S(3,2) arranged therein. The special pixel line with the special pixel line number “12” has the second group of fourth-type special pixels 21S(4,2) arranged therein. Similarly, the second group of eighth-type special pixels 21S(8,2) are arranged on the special pixel line with the special pixel line number “16”, and the third group of first-type special pixels 21S(1,3) are arranged on the special pixel line with the special pixel line number “17”. The same applies below.

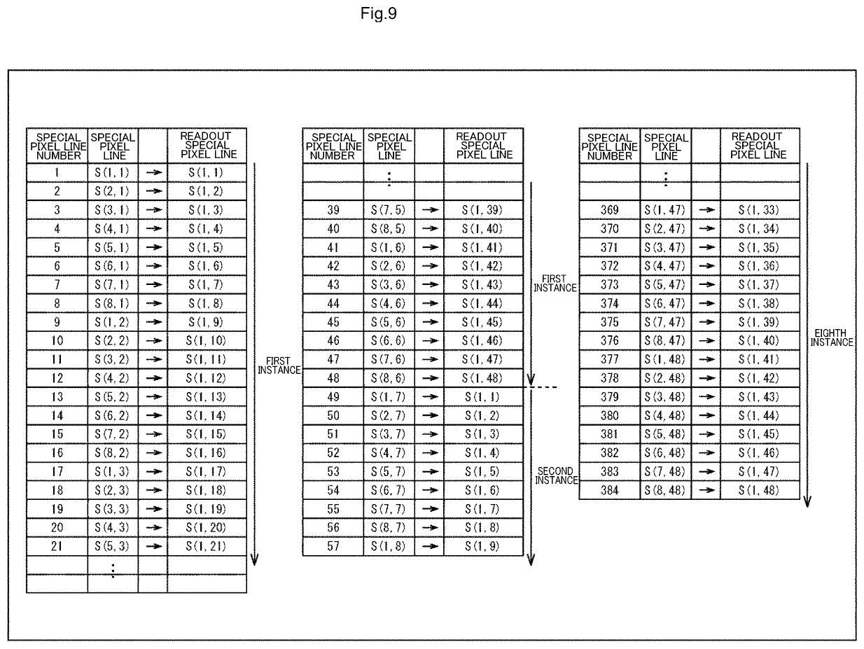

FIG. 9 is a table explaining the readout pixels of the multiple-readout drive in the second arrangement example of the special pixels 21S when the read-target special pixel 21S is the first-type special pixel 21S(1,j).

When the readout row of the pixel array unit 11 is the special pixel line with the special pixel line number “1”, the solid-state imaging device 1 reads the first group of first-type special pixels 21S(1,1) arranged on the special pixel line with the special pixel line number “1”.

Next, when the readout row of the pixel array unit 11 is the special pixel line with the special pixel line number “2”, the special pixel line with the special pixel line number “2” has the first group of second-type special pixels 21S(2,1) arranged therein, but the solid-state imaging device 1 reads the second group of first-type special pixels 21S(1,2) for the special pixels 21S.

Next, when the readout row of the pixel array unit 11 is the special pixel line with the special pixel line number “3”, the special pixel line with the special pixel line number “3” has the first group of third-type special pixels 21S(3,1) arranged therein, but the solid-state imaging device 1 reads the third group of first-type special pixels 21S(1,3) for the special pixels 21S.

Similarly, when the readout row of the pixel array unit 11 is the special pixel line, the first-type read-target special pixels 21S(1,j) are selected and read in sequence. When the readout row of the pixel array unit 11 is the special pixel line with the special pixel line number “48”, the special pixel line with the special pixel line number “48” has the sixth group of eighth-type special pixels 21S(8,6) arranged therein, but the solid-state imaging device 1 reads the 48th group of first-type special pixels 21S(1,48) for the special pixels 21S.

As a result, all the first-type special pixels 21S(1,j) of the first group to the 48th group arranged in the pixel array unit 11 have been read once. The second readout of the first-type special pixel 21S(1,j) arranged in the pixel array unit 11 starts from the readout of the next special pixel 21S.

In other words, when the next readout row of the pixel array unit 11 is the special pixel line with the special pixel line number “49”, the special pixel line with the special pixel line number “49” has the seventh group of first-type special pixels 21S(1,7) arranged therein, but the solid-state imaging device 1 performs a second readout of the first group of first-type special pixels 21S(1,1) for the special pixels 21S.

Next, when the readout row of the pixel array unit 11 is the special pixel line with the special pixel line number “50”, the special pixel line with the special pixel line number “50” has the seventh group of second-type special pixels 21S(2,7) arranged therein, but the solid-state imaging device 1 performs a second readout of the second group of first-type special pixels 21S(1,2) for the special pixels 21S.

In the same manner, when the readout row of the pixel array unit 11 is a special pixel line, the first-type read-target special pixels 21S(1,j) are selected and read in sequence.

When the readout row of the pixel array unit 11 is a special pixel line with the special pixel line number “384”, in the special pixel line with the special pixel line number “384” has the 48th group of eighth-type special pixels 21S(8,48) arranged therein, but the solid-state imaging device 1 performs the eighth readout of the 48th group of first-type special pixels 21S(1,48) for the special pixels 21S.

After the eighth readout of the 48th group of first-type special pixels 21S(1,48), the last row of the normal pixel lines of the pixel array unit 11 is read, and the readout of the pixel array unit 11 for one frame period is completed.

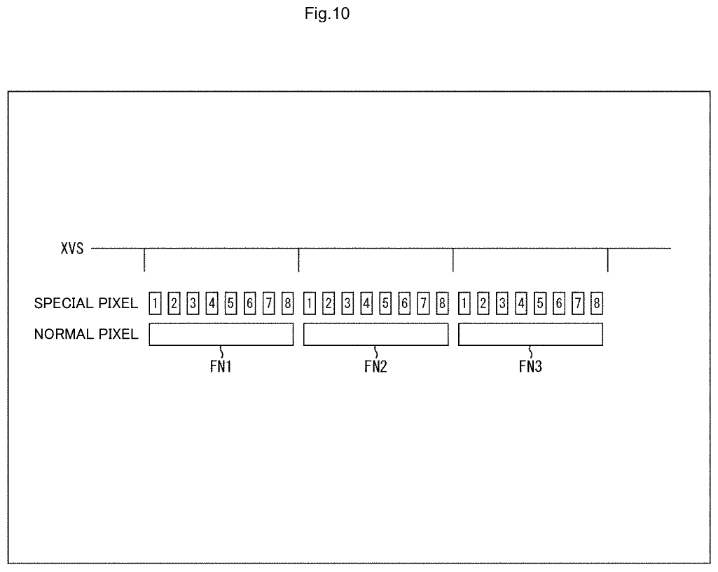

As described above, there are eight types of special pixels 21S, from the first type to the eighth type. When one of these types is selected as the read-target pixel, the read-target special pixel 21S in the pixel array unit 11 is read eight times in one frame period for generating one frame image FN, as illustrated in FIG. 10.

Furthermore, when two specific types of special pixels 21S among the eight types of special pixels 21S are selected as the read-target pixels, the read-target special pixels 21S in the pixel array unit 11 are read four times in total per pixel. Therefore, when there are N types of special pixels 21S (N is an integer, N>0) and there are M types of read-target special pixels 21S (M is an integer, N>M), the number of readout times per pixel is N/M times in total, and the readout speed is also N/M times faster than that of normal pixels 21N.

### (Exposure Time of Special Pixels)

Next, the exposure time allocated to the read-target special pixel 21S will be described.

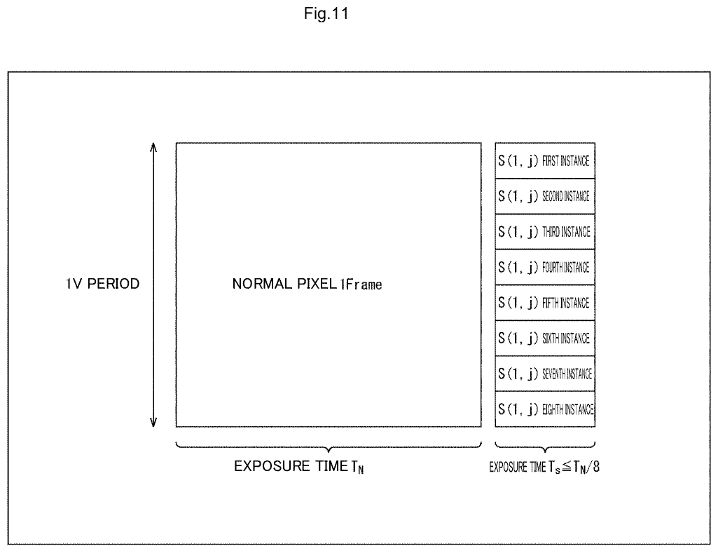

As described above, in one frame period for generating one frame image FN, one read-target special pixel 21S in the pixel array unit 11 is read eight times. Therefore, as illustrated in FIG. 11, when the exposure time of the normal pixel 21N is T_{N} and the exposure time T_{S} of the read-target special pixel 21S is the same for all eight instances, the exposure time T_{S} for one instance is ⅛ or less of the exposure time T_{N} of the normal pixel 21N (T_{S}≤T_{N}/8).

### (First Multiple-Readout Drive)

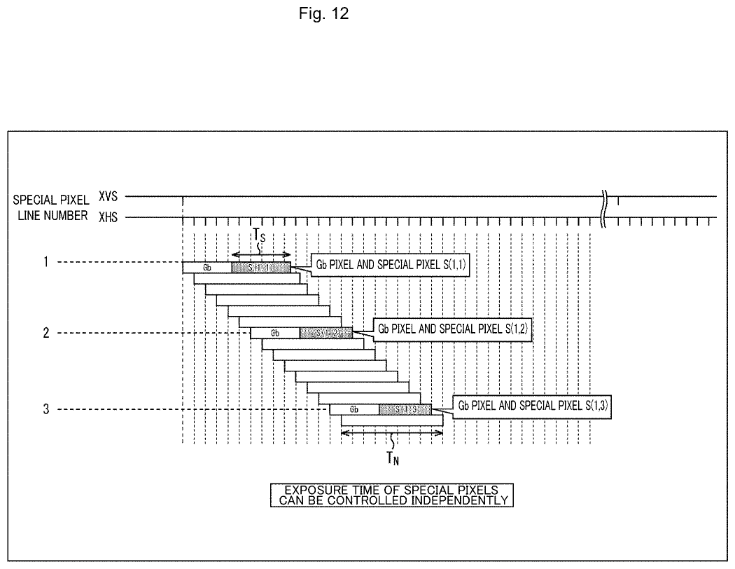

FIG. 12 is a timing chart illustrating an example of multiple-readout drive of a special pixel line in the second arrangement example of the special pixels 21S described in FIG. 8.

In the second arrangement example of the special pixels 21S described in FIG. 8, the color filters of each pixel 21 of the pixel array unit 11 are arranged in a Bayer array, the special pixel line is set to a GbB row in which Gb pixels with Gb (green) color filters and B pixels with B (blue) color filters are arranged alternately in the row direction in the Bayer array, and the special pixel 21S is arranged at a pixel position that would normally correspond to the B pixel.

In this case, as illustrated in FIG. 12, when reading the special pixel line with the special pixel line number “1”, the Gb pixel and the special pixel 21S(1,1) are read in the same 1-row readout period (hereinafter also referred to as a 1H period). The exposure time of the Gb pixel is the exposure time T_{N} of the normal pixel 21N, and the exposure time of the special pixel 21S(1,1) is an exposure time T_{S} that is ⅛ or less of the exposure time T_{N}.

When reading the next special pixel line with the special pixel line number “2”, the Gb pixel and the special pixel 21S(1,2) are read in the same 1H period. The exposure time of the Gb pixel is the exposure time T_{N} of the normal pixel 21N, and the exposure time of the special pixel 21S(1,2) is the exposure time T_{S}.

When reading the next special pixel line with the special pixel line number “3”, the Gb pixel and the special pixel 21S(1,3) are read in the same 1H period. The exposure time of the Gb pixel is the exposure time T_{N} of the normal pixel 21N, and the exposure time of the special pixel 21S(1,3) is the exposure time T_{S}.

In this way, the readout of the normal pixel 21N of the special pixel line and the readout of the read-target special pixel 21S are performed in the same 1H period, and the exposure time T_{S} of the special pixel 21S can be controlled independently of the exposure time T_{N} of the normal pixel 21N.

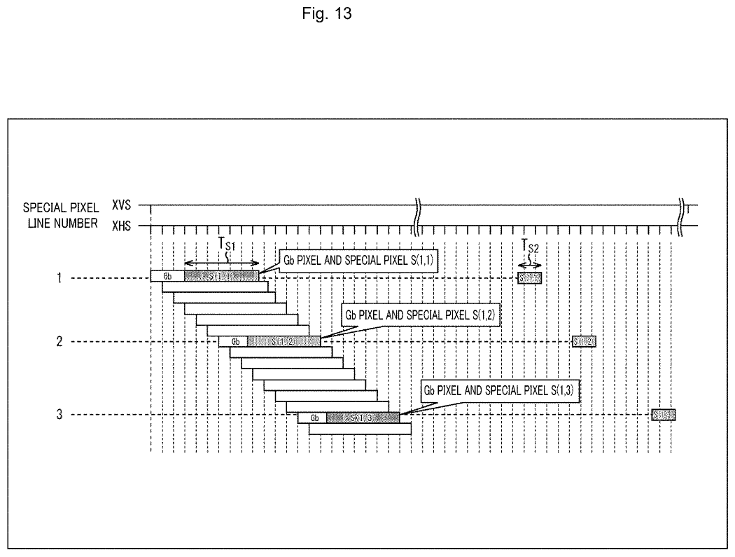

In the above example, the exposure time T_{S} of one special pixel 21S that is read a total of eight times is the same for each read, but as illustrated in FIG. 13, the exposure time T_{S} can also be controlled to be different for each read. For example, FIG. 13 shows an example in which the first exposure time T_{S1} is long, and the second and subsequent exposure times T_{S2} are controlled to be shorter than the first exposure time T_{S1}.

### (Second Multiple-Readout Drive)

If the readout drive described with reference to FIG. 12 is referred to as the first multiple-readout drive, in the first multiple-readout drive, the solid-state imaging device 1 reads the normal pixel 21N of the special pixel line and the read-target special pixel 21S in the same 1H period. In the following, the normal pixel 21N of the special pixel line and the read-target special pixel 21S may be read in different 1H periods.

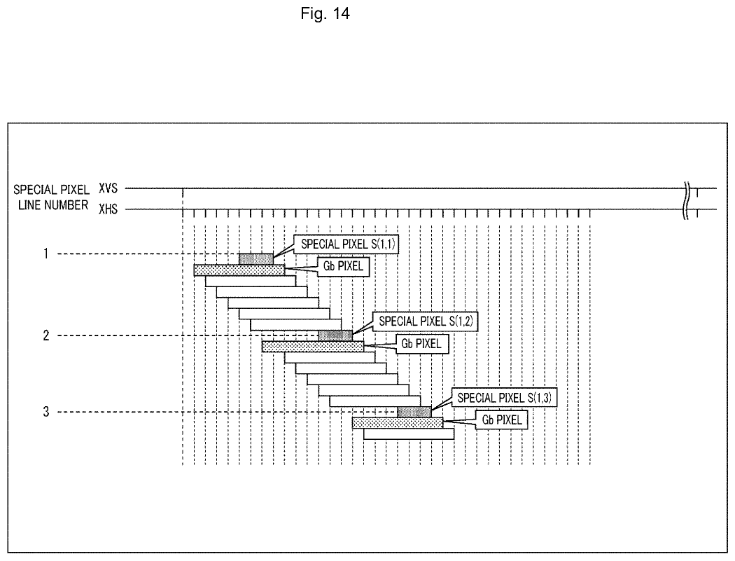

FIG. 14 is a timing chart illustrating the second multiple-readout drive that can be performed by the solid-state imaging device 1.

In the second multiple-readout drive, the solid-state imaging device 1 performs driving to read the normal pixel 21N of the special pixel line and the read-target special pixel 21S in different 1-row readout periods (1H periods). In the example of FIG. 14, a Gb pixel, which is a normal pixel 21N of the special pixel line with the special pixel line number “1”, is read in the 1 H period following the readout of the special pixel 21S(1,1) at the readout timing of the special pixel line with the special pixel line number “1”. Also, a Gb pixel, which is a normal pixel 21N of the special pixel line with the special pixel line number “2”, is read in the 1H period following the readout of the special pixel 21S(1,2) at the readout timing of the special pixel line with the special pixel line number “2”. Similarly, a Gb pixel, which is a normal pixel 21N of the special pixel line with the special pixel line number “3”, is read in the 1H period following the readout of the special pixel 21S(1,3) at the readout timing of the special pixel line with the special pixel line number “3”.

### (Third Multiple-Readout Drive)

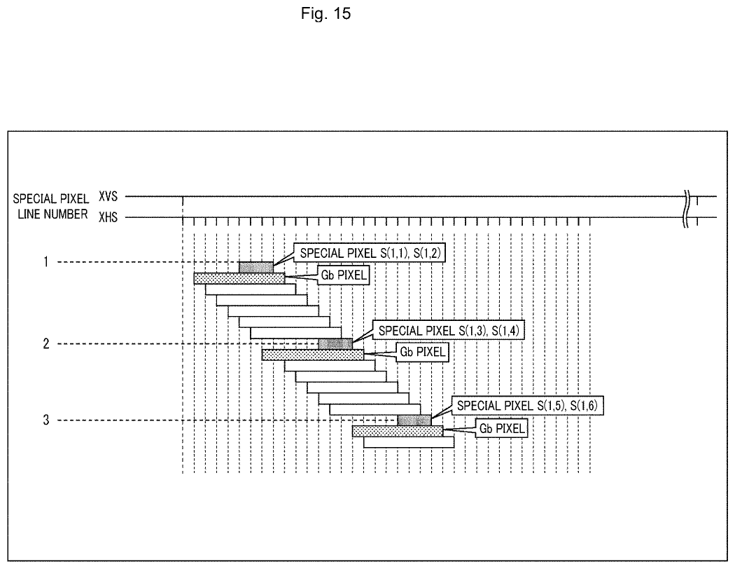

FIG. 15 is a timing chart illustrating a third multiple-readout drive that can be performed by the solid-state imaging device 1.

The third multiple-readout drive is common to the second multiple-readout drive of FIG. 14 in that the normal pixel 21N and the special pixel 21S are read in different 1H periods when reading the special pixel line. However, the third multiple-readout drive differs from the second multiple-readout drive of FIG. 14 in that two rows of read-target special pixels 21S are read in the 1H period when the special pixel 21S is read.

In the example of FIG. 15, at the readout timing of the special pixel line with the special pixel line number “1”, the special pixel 21S(1,1) and the special pixel 21S(1,2), which is the next read-target special pixel 21S, are read. The two rows of the read-target special pixel 21S(1,1) and the special pixels 21S(1,2) are read in a time-division manner. Then, in the next 1H period, the Gb pixel which is the normal pixel 21N of the special pixel line with the special pixel line number “1” is read.

At the readout timing of the next special pixel line with the special pixel line number “2”, the special pixel 21S(1,3) and the special pixel 21S(1,4) that are the next read-target special pixels 21S are read. Then, during the next 1H period, the Gb pixel that is the normal pixel 21N of the special pixel line with the special pixel line number “2” is read.

At the readout timing of the next special pixel line with the special pixel line number “3”, the special pixel 21S(1,5) and the special pixel 21S(1,6) that are the next read-target special pixels 21S are read. Then, during the next 1H period, the Gb pixel that is the normal pixel 21N of the special pixel line with the special pixel line number “3” is read.

In this way, since the exposure time T_{S} of the special pixels 21S is shorter than the exposure time T_{N} of the normal pixels 21N, and pixels can be read at high speed, the solid-state imaging device can be driven so that the special pixels 21S of two special pixel lines are read in a 1H period.

### 8. Example of Solid-State Imaging Device with Double ADC Configuration

In the above-mentioned embodiment, as described with reference to FIG. 1, the column processing unit 13 of the solid-state imaging device 1 has one ADC 25 for one pixel column.

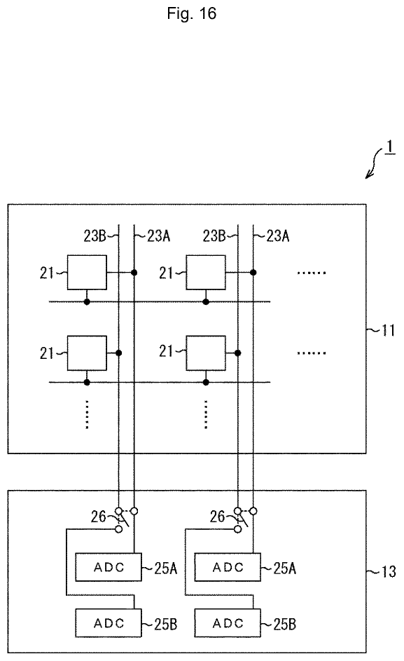

However, as the configuration of the column processing unit 13 of the solid-state imaging device 1, a double ADC configuration in which two ADCs 25 are provided for one pixel column, as illustrated in FIG. 16, can also be adopted.

FIG. 16 is a block diagram of the pixel array unit 11 and column processing unit 13 of a double ADC configuration in which two ADCs 25 are provided for one pixel column in the column processing unit 13, which is another circuit configuration of the solid-state imaging device 1.

In the solid-state imaging device 1 with a double ADC configuration, two vertical signal lines 23A and 23B are wired for one pixel column in the pixel array unit 11. For example, the pixels 21 in odd rows are connected to the vertical signal line 23A, and the pixels 21 in even rows are connected to the vertical signal line 23B. Furthermore, in the column processing unit 13, two ADCs 25A and 25B are provided for one pixel column. The ADC 25A is connected to the vertical signal line 23A, and the ADC 25B is connected to the vertical signal line 23B via a switch 26. The switch 26 switches between the ADC 25A and the ADC 25B as the output destination of the signal transmitted through the vertical signal line 23B.

For example, in a double ADC mode in which two ADCs 25 are operated for one pixel column, the system control unit 15 connects the switch 26 to the ADC 25B side and outputs the signal transmitted through the vertical signal line 23B to the ADC 25B. On the other hand, in the single ADC mode in which only one ADC 25 operates for one pixel column, the system control unit 15 connects the switch 26 to the ADC 25A side and outputs the signal transmitted through the vertical signal line 23B to the ADC 25A. Instead of selecting the ADC 25A or the ADC 25B as the signal output destination for only the signal transmitted through the vertical signal line 23B, the system control unit 15 may be configured to switch (select) for each row whether the signal is output to the ADC 25A or the ADC 25B for each of the signals transmitted through the vertical signal line 23A and the vertical signal line 23B. The solid-state imaging device 1 may also be configured to have three or more ADCs 25 for one pixel column.

### (Fourth Multiple-Readout Drive)

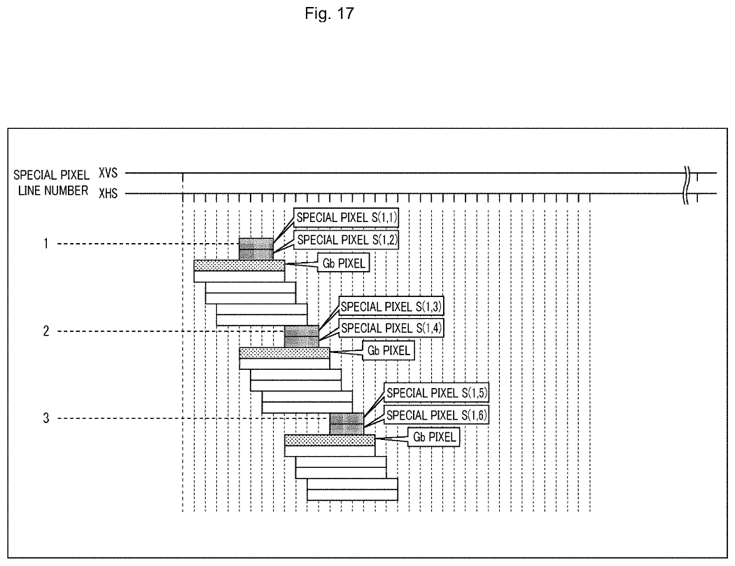

FIG. 17 is a timing chart illustrating the fourth multiple-readout drive when the solid-state imaging device 1 has a double ADC configuration and is driven in the double ADC mode.

In the fourth multiple-readout drive, the solid-state imaging device 1 performs driving to simultaneously read the special pixels 21S of the two special pixel lines at the readout timing of the special pixel line. In the example of FIG. 17, at the readout timing of the special pixel line with the special pixel line number “1”, the special pixel 21S(1,1) and the special pixel 21S(1,2) which is the next read-target special pixel 21S are simultaneously read and AD-converted. Then, in the next 1H period, the Gb pixel which is the normal pixel 21N of the special pixel line with the special pixel line number “1” is read and output to one of the two ADCs 25 in the same column.

At the readout timing of the next special pixel line with the special pixel line number “2”, the special pixels 21S(1,3) and the special pixel 21S(1,4) which are the next read-target special pixels 21S are simultaneously read and AD-converted. Then, in the next 1H period, a Gb pixel, which is a normal pixel 21N in the special pixel line with the special pixel line number “2”, is read and output to one of the two ADCs 25 in the same column.

At the readout timing of the next special pixel line with the special pixel line number “3”, the special pixels 21S(1,5) and 21S(1,6), which are the next read-target special pixels 21S, are read simultaneously and AD-converted. Then, in the next 1H period, a Gb pixel, which is a normal pixel 21N in the special pixel line with the special pixel line number “3”, is read and output to one of the two ADCs 25 in the same column.

In this way, when the solid-state imaging device 1 has a double ADC configuration, in the double ADC mode, two rows of read-target special pixels 21S(1,j) can be read simultaneously and output to the two ADCs 25 in the same column, and AD conversion can be performed simultaneously.

The solid-state imaging device 1 having a double ADC configuration can perform the above-mentioned first to third multiple-readout drive in the single ADC mode. The solid-state imaging device 1 having a double ADC configuration can also perform the above-mentioned first to third multiple-readout drive in the double ADC mode by simultaneously reading pixel signals of two rows in a 1H period, outputting them to two ADCs 25 in the same column, and simultaneously performing AD conversion.

### 9. Summary

As described above, the solid-state imaging device 1 includes the pixel array unit 11 in which pixels 21 including normal pixels 21N and special pixels 21S are arranged two-dimensionally in a matrix, and the vertical driving unit 12 that controls the readout of signals generated by the pixels 21. The vertical driving unit 12 performs control to read the read-target special pixel 21S multiple times during a single screen readout period (1V period) in which all normal pixels 21N of the pixel array unit 11 are read once. This allows the special pixel 21S of the read-target type to be read multiple times during one sequence for reading a single screen. This improves the detection accuracy of the signal from the read-target special pixel 21S, improving the focus accuracy and recognition accuracy, and improving the image quality of the captured image.

### 10. Exemplary Application to Electronic Apparatuses

The technology of the present disclosure is not limited to an application to a solid-state imaging device. In other words, the technology of the present disclosure can be generally applied to electronic apparatuses using solid-state imaging devices in image capturing units (photoelectric conversion units), such as an imaging device for a digital still camera or a video camera, a mobile terminal device having an imaging function, and a copy machine using a solid-state imaging device in an image reading unit. The solid-state imaging device may be in the form of a single chip, or may be in a module form having an imaging function, in which an imaging unit and a signal processing unit or an optical system are packaged together.

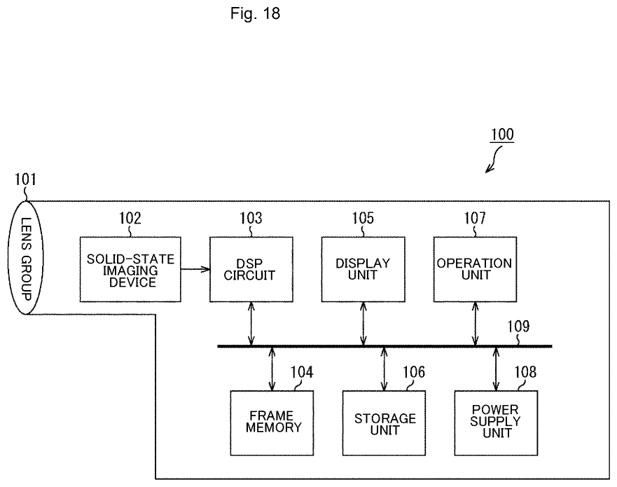

FIG. 18 is a block diagram illustrating a configuration example of an imaging device as an electronic apparatus to which the technology of the present disclosure is applied.

An imaging device 100 in FIG. 18 includes an optical unit 101 constituted by a lens group and the like, a The solid-state imaging device (an imaging device) 102 has the configuration of the solid-state imaging device 1 in FIG. 1, and a digital signal processor (DSP) circuit 103 serves as a camera signal processing circuit. The imaging device 100 also includes a frame memory 104, a display unit 105, a recording unit 106, an operation unit 107, and a power supply unit 108. The DSP circuit 103, the frame memory 104, the display unit 105, the recording unit 106, the operation unit 107, and the power supply unit 108 are connected via a bus line 109.

The optical unit 101 captures incident light (image light) from a subject and forms an image on the imaging surface of the solid-state imaging device 102. The solid-state imaging device 102 converts the amount of incident light formed on the imaging surface by the optical unit 101 into an electrical signal on a pixel-by-pixel basis and outputs the signal as a pixel signal. As the solid-state imaging device 102, the solid-state imaging device 1 of FIG. 1 can be used, that is, a solid-state imaging device that has a pixel array unit 11 in which two types of pixels 21, normal pixels 21N and special pixels 21S, are arranged in a mixed manner, and that can perform control to read the read-target special pixels 21S multiple times during a single screen readout period (1V period).

The display unit 105 is configured of, for example, a thin display such as a liquid crystal display (LCD) or an organic electro luminescence (EL) display, for example, and displays a moving image or a still image captured by the solid-state imaging device 102. The recording unit 106 records the moving image or the still image captured by the solid-state imaging device 102 in a recording medium, e.g., a hard disk or a semiconductor memory.

The operation unit 107 issues operator commands for various functions of the imaging device 100 on the basis of a user operation. The power supply unit 108 appropriately supplies various types of power serving as operation power supplies of the DSP circuit 103, the frame memory 104, the display unit 105, the recording unit 106, and the operation unit 107 to supply targets.

As described above, by using the solid-state imaging device 1 to which the above-mentioned embodiment is applied as the solid-state imaging device 102, the detection accuracy of the readout read-target special pixel 21S is improved. As a result, even in the imaging device 100 such as a video camera, a digital still camera, and even a camera module for mobile devices such as a mobile phone, it is possible to improve the focus accuracy and recognition accuracy, and to achieve high image quality of the captured image.

### Exemplary Use of Image Sensor

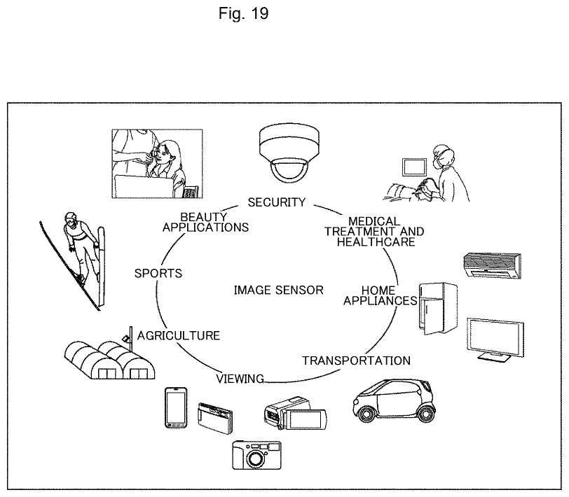

FIG. 19 is a diagram illustrating an example of how an image sensor including the solid-state imaging device 1 is used.

The mentioned solid-state imaging device 1 can be used for various cases that sense light such as visible light, infrared light, ultraviolet light, and X-rays as follows, for example, as an image sensor.
Devices that capture images used for viewing, such as digital cameras and mobile devices with camera functions
Devices used for transportation, such as in-vehicle sensors that capture front, rear, peripheral, and interior view images of automobiles, monitoring cameras that monitor traveling vehicles and roads, range sensors that measure distances between vehicles, and the like, for driving safety features such as automatic stopping, recognizing the state of the driver, and the like
Devices used for home appliances such as TVs, refrigerators, and air conditioners in order to capture an image of a user's gesture and perform device operations in accordance with the gesture
Devices used for medical treatment and healthcare, such as endoscopes and devices that perform angiography by receiving infrared light
Devices used for security, such as surveillance cameras for crime prevention and cameras for personal authentication
Devices used in beauty applications, such as skin measuring devices that capture images of the skin and microscopes that capture images of the scalp
Devices used for sports, such as action cameras and wearable cameras for sports applications
Devices used for agriculture, such as cameras for monitoring the states of fields and crops

The embodiments of the present disclosure are not limited to the above-described embodiments, and various modifications can be made without departing from the essential spirit of the technology of the present disclosure. For example, a form in which some or all of the above-described embodiments are combined as appropriate may be employed as well.

The advantageous effects described in the present specification are merely exemplary and are not limited, and other advantageous effects of those described in the present specification may be achieved.

The technology of the present disclosure can be configured as follows.
(1)

A solid-state imaging device including:
a pixel array unit in which a plurality of pixels including normal pixels and special pixels are arranged two-dimensionally in a matrix; and
a driving unit that controls reading of signals generated by the pixels, wherein
the driving unit performs control to read a predetermined special pixel out of the special pixels multiple times during a single-screen readout period in which the normal pixels of the pixel array unit are read once.
(2)

The solid-state imaging device according to (1), wherein
the special pixels include a plurality of types of special pixels, and
the driving unit performs control to read a predetermined type of the special pixels multiple times from among the plurality of types of special pixels of the pixel array unit.
(3)

The solid-state imaging device according to (2), wherein
when the number of types of the special pixels is N (N>0) and the number of types of read-target special pixels is M (M>0, N>M),
the driving unit performs control to read the read-target special pixel N/M times.

(4)

The solid-state imaging device according to (2) or (3), wherein
the same type of the special pixels are arranged in a predetermined row of the pixel array unit, and different types of the special pixels are arranged in different rows.
(5)

The solid-state imaging device according to any one of (1) to (4), wherein
when a readout row of the pixel array unit is a row including the special pixels, with regard to reading of the special pixels the driving unit sequentially selects rows including the read-target special pixels and reads the signals of the read-target special pixels.
(6)

The solid-state imaging device according to any one of (1) to (5), wherein
when the readout row of the pixel array unit is a row including the special pixels,
the driving unit skips reading the special pixels other than the read-target special pixels.
(7)

The solid-state imaging device according to any one of (1) to (6), wherein
the driving unit controls an exposure time of the predetermined read-target special pixels independently of an exposure time of the normal pixels.
(8)

The solid-state imaging device according to any one of (1) to (7), wherein
an exposure time for each instance of the predetermined special pixel that is read multiple times is the same.
(9)

The solid-state imaging device according to any one of (1) to (7), wherein
an exposure time for each instance of the predetermined special pixel that is read multiple times differs.
(10)

The solid-state imaging device according to any one of (1) to (9), wherein
when the readout row of the pixel array unit is a row including the special pixels,
the driving unit reads the read-target special pixel and the normal pixel of the readout row in the same 1-row readout period.
(11)

The solid-state imaging device according to any one of (1) to (9), wherein
when the readout row of the pixel array unit is a row including the special pixels,
the driving unit reads the read-target special pixel and the normal pixel of the readout row in different 1-row readout periods.
(12)

The solid-state imaging device according to (11), wherein
the driving unit reads two rows of read-target special pixels in a 1-row readout period.
(13)

The solid-state imaging device according to (12), wherein
the driving unit reads two rows of read-target special pixels in a time-division manner.
(14)

The solid-state imaging device according to (12), wherein
the driving unit simultaneously reads two rows of read-target special pixels.
(15)

The solid-state imaging device according to any one of (1) to (14), further including:
a plurality of ADCs for one pixel row.
(16)

The solid-state imaging device according to any one of (1) to (15), wherein
the special pixel is a phase-difference pixel.
(17)

The solid-state imaging device according to any one of (1) to (16), wherein
the special pixels are each a detection pixel for recognition processing.
(18)

The solid-state imaging device according to any one of (1) to (17), wherein
the special pixels are each a functional pixel having a specific function.
(19)

A method for driving a solid-state imaging device including a pixel array unit in which a plurality of pixels including normal pixels and special pixels are arranged two-dimensionally in a matrix, and a driving unit that controls reading of signals generated by the pixels, the method including:
causing the driving unit to perform control to read a predetermined special pixel out of the special pixels multiple times during a single-screen readout period in which the normal pixels of the pixel array unit are read once.
(20)

An electronic apparatus including a solid-state imaging device including:
a pixel array unit in which a plurality of pixels including normal pixels and special pixels are arranged two-dimensionally in a matrix; and
a driving unit that controls reading of signals generated by the pixels, wherein
the driving unit performs control to read a predetermined special pixel out of the special pixels multiple times during a single-screen readout period in which the normal pixels of the pixel array unit are read once.

### REFERENCE SIGNS LIST

1 Solid-state imaging device
11 Pixel array unit
12 Vertical driving unit
13 Column processing unit
14 Horizontal driving unit
15 System control unit
21 Pixel
21N Normal pixel
21S(21Sa, 21Sb, 21Sc) Special pixel
22 Pixel drive wiring
23 Vertical signal line
100 Imaging device
102 Solid-state imaging device
AF In-plane phase-difference signal
AFa1-1 In-plane phase-difference signal
AFa2-1 In-plane phase-difference signal
AFa3-1In-plane phase-difference signal
FN Frame image
XVS Vertical synchronization signal

1. A solid-state imaging device comprising:
a pixel array unit in which a plurality of pixels including normal pixels and special pixels are arranged two-dimensionally in a matrix; and
a driving unit that controls reading of signals generated by the pixels, wherein
the driving unit performs control to read a predetermined special pixel out of the special pixels multiple times during a single-screen readout period in which the normal pixels of the pixel array unit are read once.

2. The solid-state imaging device according to claim 1, wherein
the special pixels include a plurality of types of special pixels, and
the driving unit performs control to read a predetermined type of the special pixels multiple times from among the plurality of types of special pixels of the pixel array unit.

3. The solid-state imaging device according to claim 2, wherein
when the number of types of the special pixels is N (N>0) and the number of types of read-target special pixels is M (M>0, N>M), the driving unit performs control to read the read-target special pixel N/M times.

4. The solid-state imaging device according to claim 2, wherein
the same type of the special pixels are arranged in a predetermined row of the pixel array unit, and different types of the special pixels are arranged in different rows.

5. The solid-state imaging device according to claim 1, wherein
when a readout row of the pixel array unit is a row including the special pixels, with regard to reading of the special pixels the driving unit
sequentially selects rows including the read-target special pixels and reads signals of the read-target special pixels.

6. The solid-state imaging device according to claim 1, wherein
when the readout row of the pixel array unit is a row including the special pixels,
the driving unit skips reading the special pixels other than the read-target special pixels.

7. The solid-state imaging device according to claim 1, wherein
the driving unit controls an exposure time of the predetermined read-target special pixels independently of an exposure time of the normal pixels.

8. The solid-state imaging device according to claim 1, wherein
an exposure time for each instance of the predetermined special pixel that is read multiple times is the same.

9. The solid-state imaging device according to claim 1, wherein
an exposure time for each instance of the predetermined special pixel that is read multiple times differs.

10. The solid-state imaging device according to claim 1, wherein
when the readout row of the pixel array unit is a row including the special pixels, the driving unit reads the read-target special pixel and the normal pixel of the readout row in a same 1-row readout period.

11. The solid-state imaging device according to claim 1, wherein
when the readout row of the pixel array unit is a row including the special pixels,
the driving unit reads the read-target special pixel and the normal pixel of the readout row in different 1-row readout periods.

12. The solid-state imaging device according to claim 11, wherein
the driving unit reads two rows of read-target special pixels in a 1-row readout period.

13. The solid-state imaging device according to claim 12, wherein
the driving unit reads two rows of read-target special pixels in a time-division manner.

14. The solid-state imaging device according to claim 12, wherein
the driving unit simultaneously reads two rows of read-target special pixels.

15. The solid-state imaging device according to claim 1, further comprising:
a plurality of ADCs for one pixel row.

16. The solid-state imaging device according to claim 1, wherein
the special pixel is a phase-difference pixel.

17. The solid-state imaging device according to claim 1, wherein
the special pixels are each a detection pixel for recognition processing.

18. The solid-state imaging device according to claim 1, wherein
the special pixels are ach a functional pixel having a specific function.

19. A method for driving a solid-state imaging device including a pixel array unit in which a plurality of pixels including normal pixels and special pixels are arranged two-dimensionally in a matrix, and a driving unit that controls reading of signals generated by the pixels, the method comprising:
causing the driving unit to perform control to read a predetermined special pixel out of the special pixels multiple times during a single-screen readout period in which the normal pixels of the pixel array unit are read once.

20. An electronic apparatus comprising a solid-state imaging device including:
a pixel array unit in which a plurality of pixels including normal pixels and special pixels are arranged two-dimensionally in a matrix; and
a driving unit that controls reading of signals generated by the pixels, wherein
the driving unit performs control to read a predetermined special pixel out of the special pixels multiple times during a single-screen readout period in which the normal pixels of the pixel array unit are read once.
